(19) United States
(12) Patent Application Publication
(10) Pub. No.: US 2022/0032762 A1
(43) Pub. Date: Feb. 3, 2022

(54) TORQUE TRANSMISSION APPARATUS FOR THE TRANSMISSION OF A TORQUE TO A TRANSMISSION OF A VEHICLE WHICH CAN BE DRIVEN VIA A HYBRID DRIVE

(71) Applicant: ZF Friedrichshafen AG, Friedrichshafen (DE)

(72) Inventor: Stefan Simon, Magdeburg (DE)

(73) Assignee: ZF Friedrichshafen AG, Friedrichshafen (DE)

(21) Appl. No.: 17/386,857

(22) Filed: Jul. 28, 2021

(30) Foreign Application Priority Data
Jul. 28, 2020 (DE) 102020209461.6

(51) Int. Cl. B60K 6/387; B60K 6/405; F16D 25/12; F16H 57/04; F16H 57/023; F16H 57/021; B60K 6/48

(52) U.S. Cl. CPC B60K 6/387; B60K 6/405; F16D 25/12; F16H 57/043; F16H 2057/02034; F16H 57/021; B60K 6/48; B60Y 2200/92; B60K 2006/4825; F16H 57/023

(57) ABSTRACT

A torque transmission apparatus for transmission of a torque to a transmission of a vehicle which can be driven via a hybrid drive is disclosed. The torque transmission apparatus comprises an input shaft, a rotor shaft, and a clutch device. The input shaft can be connected or is connected in a torque-transmitting manner to an internal combustion engine. The rotor shaft can be connected or is connected in a torque-transmitting manner to an electric machine. The clutch device connects the input shaft and the rotor shaft at least temporarily in a torque-transmitting manner. The clutch device can be configured in a first operating state, to transmit a torque between the input shaft and a transmission shaft which is assigned to a transmission via the rotor shaft. The crutch device can also be configured in a further operating state to transmit a reduced torque or no torque between the input shaft and the transmission shaft. The input shaft has a receiving section, for indirectly or directly receiving a section of the rotor shaft, and/or the rotor shaft having a receiving section for indirectly or directly receiving a section of the input shaft.

### CROSS-REFERENCE TO RELATED APPLICATION

This application claims priority to German Patent Application No. 102020209461.6 filed Jul. 28, 2020, the disclosure of which is incorporated herein by reference in its entirety.

### TECHNICAL FIELD

The disclosure relates to a torque transmission apparatus for the transmission of a torque to a transmission of a vehicle which can be driven via a hybrid drive.

### BACKGROUND

Corresponding torque transmission apparatuses are fundamentally known from the prior art. It is thus known, for example, for an internal combustion engine and an electric machine to be connected via respective transmission shafts to a vehicle-side transmission, in order selectively to transmit a torque of an internal combustion engine and a torque of an electric machine to the transmission. An operation of the internal combustion engine at the same time as an electric machine is also possible, with the result that a torque proportion of the internal combustion engine and a torque proportion of the electric machine are introduced at the same time to the transmission.

### SUMMARY

The disclosure is based on specifying a torque transmission apparatus for the transmission of a torque to a transmission of a vehicle which can be driven via a hybrid drive, which torque transmission apparatus makes a high load-bearing capability and reliability, a high degree of efficiency and a compact overall design of the torque transmission apparatus possible, in particular with regard to a simple and inexpensive measure.

A torque transmission apparatus is disclosed, as well as a transmission arrangement. A vehicle is also disclosed, as well as a method.

The torque transmission apparatus serves to transmit a torque to a transmission of a vehicle which can be driven via a hybrid drive. Here, the vehicle can be, in one exemplary arrangement, a motor vehicle. The torque transmission apparatus has an input shaft which can be connected in a torque-transmitting manner to an internal combustion engine or, in a final assembled state or in use as intended of the torque transmission apparatus, is connected to the input shaft. Furthermore, an electric machine can be connected in a torque-transmitting manner to a torque transmission apparatus-side rotor shaft, or is at least connected to it in the use as intended. The input shaft and the rotor shaft are connected or can be connected at least temporarily in a torque-transmitting manner via a clutch device, the clutch device being configured, a) in a first operating state of the clutch device, to transmit a torque between the input shaft and a transmission shaft which is assigned to a transmission via the rotor shaft or to transmit it between the input shaft and the rotor shaft, and b) in a further operating state, to transmit a reduced torque or no torque between the input shaft and the transmission shaft or between the input shaft and the rotor shaft. In the first operating state, starting from the internal combustion engine, a torque can be transmitted via the input shaft, from the input shaft via the clutch device to the rotor shaft, and can possibly be transmitted from the rotor shaft directly or indirectly to a transmission shaft of a transmission. In a further operating state, the input shaft and the rotor shaft are not connected or are connected to a lesser extent (dragging clutch state or slip state) in a torque-transmitting manner by way of a corresponding actuation of the clutch device. The input shaft and the rotor shaft are configured in such a way that a) the input shaft has a receiving section, in one exemplary arrangement, in the form of a recess, for direct or indirect receiving of a section of the rotor shaft, and/or b) the rotor shaft has a receiving section, in particular in the form of a recess, for indirect or direct receiving of a section of the input shaft. By virtue of the fact that the, in particular axial, extent of the input shaft and rotor shaft engage into one another at least in sections, a shortened overall design (in the axial extent) can be achieved. A construction which is optimized overall for the torque transmission apparatus or for the entire transmission arrangement or for the entire drive train, in particular an overall design which is shortened in the axial direction, can also be achieved. Combustion engines in general are to be understood under the term of internal combustion engine.

The rotor element can comprise, for example, a constituent part, in particular the rotor constituent part, of the electric machine, or said constituent part of the electric machine can be connected fixedly to the rotor body, in particular can be connected in a non-positive and/or positively locking and/or integrally joined manner.

The torque transmission apparatus can be set up, for example, during the first operating state of the clutch device, to transmit a torque of the input shaft, in particular exclusively, via the rotor shaft indirectly or directly to the transmission shaft of the transmission. A first clutch arrangement of the clutch device can be arranged or configured or fastened in a torque-transmitting manner, for example, on the input shaft, and a further exemplary clutch arrangement of the clutch device can be arranged or configured or fastened in a torque-transmitting manner on the rotor shaft. The transmission can comprise, for example, a double clutch.

It is also possible that a) the rotor shaft and the input shaft are oriented coaxially with respect to one another, and b) the rotor shaft and/or the input shaft are/is configured as a hollow shaft. In this way, the rotor shaft and the input shaft can be configured or arranged as shafts which are oriented coaxially with respect to one another and engage into one another at least in sections.

The rotor shaft can be connected or can be capable of being connected in a torque-transmitting manner, for example, via a connecting body or a connecting shaft to a transmission shaft. The connecting body can be configured, for example, as a hollow shaft or hollow body which can be connected or is connected in a torque-transmitting manner to the rotor shaft and to the transmission shaft. As an alternative or in addition, the connecting body can be oriented coaxially with respect to the rotor shaft and preferably additionally coaxially with respect to the input shaft at least in the final assembly state. The connecting body can configure a plug-in connection, for example, with the rotor shaft. The connecting body can be pressed, for example, to the rotor shaft, or can be connected via a press fit in a non-positive and/or positively locking manner to the rotor shaft. The connecting body which is configured, in particular, as a connecting shaft can have, for example, at least two outer sections, a first section serving at least for the positively locking connection, for example fine toothing and/or stub toothing and/or spline toothing, of the connecting shaft to the rotor shaft, and at least one further section serving for centering during assembling of the connecting shaft and the rotor shaft. As an alternative or in addition, the further section can act in a play-reducing manner on the connection of the connecting shaft and the rotor shaft; for example, radial shocks or movements can be reduced by way of the further section by way of the reduction of a potential movement travel on account of the reduced-play final assembly state at least in this region. Play-reducing measures of this type are advantageous in such a way that a mounting means (for example, further mounting means) of a bearing device for mounting the rotor shaft on a housing body is subjected to smaller loads, in particular radial shocks. The connecting body can be configured, for example, as a cup-shaped hollow body, the interior space of which is closed on one end side. As an alternative, the connecting body can be configured as a sleeve body which has an opening which is, in particular, continuous on both end sides.

It is possible that the input shaft and the rotor shaft are mounted such that they can be moved rotationally with respect to one another, in particular directly, via a mounting device. In one exemplary arrangement, the mounting device has at least one radial mounting arrangement and at least one axial mounting arrangement. Advantageous support and a compact overall design can be achieved by way of a mounting device which is optionally arranged or configured directly in or on the rotor shaft and the input shaft. Here, the direct arrangement of the mounting device comprises, for example, that a bearing constituent part of the mounting device is directly in contact with the rotor shaft, and the same bearing constituent part or a further bearing constituent part of the mounting device is directly in contact with the input shaft. The mounting device can comprise, for example, at least one radial mounting arrangement which mounts the rotor shaft and the input shaft in the radial direction with respect to one another or supports them with regard to radially acting forces. As an alternative or in addition, the mounting device can comprise at least one axial mounting arrangement which mounts the rotor shaft and the input shaft with respect to one another in the axial direction or supports them with regard to axially acting forces.

For example, a radial mounting arrangement is configured as a mounting which comprises one or two or more needle bearing rings, and can therefore comprise one needle bearing ring or a plurality of needle rings. The axial mounting arrangement can be configured, for example, as an axial needle bearing.

It is possible that the mounting device is received at least partially, and in one exemplary arrangement, in a) an inner region of the input shaft, which inner region receives the rotor shaft, or b) in an inner region of the rotor shaft, which inner region receives the input shaft, and all the mounting arrangements of the mounting device may be received in an inner region of the rotor shaft or of the input shaft for direct or immediate mutual mounting of the rotor shaft and the input shaft. A construction of this type makes a compact overall design possible. At least two, and in one exemplary arrangement, all of the mounting arrangements (for example, axial mounting arrangement and radial mounting arrangements) may be arranged or configured on a common cavity or in a common interior space of the rotor shaft or the input shaft.

By virtue of the fact that the torque transmission apparatus comprises a mounting device for mounting the rotor shaft with the drive shaft, and in one exemplary arrangement, comprising merely one radial mounting arrangement which transmits exclusively radial bearing forces and merely one axial mounting arrangement which transmits exclusively axial bearing forces, and said drive shaft and rotor shaft assembly mounted in this way is itself mounted via a first bearing arrangement which absorbs, in particular, radial and axial bearing forces, and via a further bearing arrangement which absorbs, in particular, exclusively radial bearing forces, the result is a construction of the torque transmission apparatus which has a high degree of efficiency and therefore low friction losses on account of the mounting. In other words, the mounting between the rotor shaft and the input shaft can comprise merely two bearings, a first bearing acting exclusively in a radially mounting manner and the further acting exclusively in an axially mounting manner, for example two floating bearings. The rotor shaft/input shaft assembly can be connected to a superordinate assembly or can be mounted rotatably via a first bearing which absorbs exclusively radial forces and a further bearing which absorbs radial and axial forces; for example, the rotor shaft/input shaft assembly is mounted rotatably relative to a housing body via a locating bearing and a floating bearing.

It can be provided in a further advantageous exemplary arrangement that the input shaft and/or the rotor shaft are/is mounted, in particular are/is supported in a rotationally movable manner, indirectly or directly via a bearing device with a housing body which surrounds the clutch device and/or the input shaft and/or the rotor shaft at least in sections, in particular completely. The input shaft is preferably mounted via a first bearing arrangement on a housing part body of the housing body, and the rotor shaft is preferably mounted via a further bearing arrangement on a further housing part body of the housing body. The housing body can have, for example, an at least two-piece construction, and in one exemplary arrangement, an at least three-piece construction, it being possible for a first housing part body to be assigned via a first bearing arrangement to the input shaft and for a further housing part body to be assigned via the further bearing arrangement to the rotor shaft, and it being possible for a central housing part body to serve as a connecting body of the first and the further housing part body. Here, the central housing part body can have a sleeve-like, in particular substantially cylindrical, construction. The central housing part body can receive, for example in its interior space, the clutch device and at least in sections the rotor shaft and the input shaft. At least one bearing arrangement can be configured, for example, as a radial bearing. In particular, for example, a first bearing arrangement can be configured as a groove ball bearing and/or as a locating bearing, and a further bearing arrangement can be configured as a cylindrical roller bearing and/or as a floating bearing. Here, the overall system can comprise a locating and floating mounting which extends over the two shafts, it being possible for the locating mounting to be arranged or configured on the input shaft and for the floating mounting to be arranged or configured on the rotor shaft. The first bearing arrangement can be arranged or configured, for example, for mounting the input shaft on the housing body, in particular a housing part body, as viewed in the axial direction between the radial mounting arrangement and the axial mounting arrangement for mounting the input shaft with the rotor shaft. The housing body, in particular at least one housing part body, can comprise an axially extending channel section which at least in sections delimits at least one fluid channel which is delimited via seals. The housing part body can be configured at least partially, in particular all the housing part bodies can be configured, as separate components and can be connected to one another, and in one exemplary arrangement, in a releasable, non-positive and/or positively locking manner.

It is possible that in one exemplary arrangement, a spacer element is arranged or configured between a) the input shaft and b) a housing body which surrounds the clutch device and/or the input shaft and/or the rotor shaft at least in sections. The spacer element which is arranged or configured between the input shaft and the housing body can be configured, for example, as a spacer disk and/or spacer ring. A defined spacing may be set or produced by way of the spacer element in the axial direction between the input shaft and the housing body. The spacer element can be arranged, for example, directly between the bearing arrangement and the rotor shaft and therefore in direct contact between the bearing arrangement and the rotor shaft. As an alternative or in addition, the spacer element can also be arranged between the housing body, in particular housing part body, and the mounting arrangement. In principle, two spacer elements can also be arranged, a first spacer element being arranged on that side of the bearing arrangement which faces the housing part body, and the further spacer element being arranged on that side of the bearing arrangement which faces the rotor shaft.

In a further advantageous exemplary arrangement, a housing body, for example, a housing part body, which surrounds the clutch device and/or the input shaft and/or the rotor shaft at least in sections comprises a connecting channel which connects a housing body space, which receives the clutch device at least in sections, and in one exemplary arrangement, completely, to a region which faces away from said housing body space, in such a way that, when the torque transmission apparatus is used as intended, a fluid which is situated in the housing body space passes via the connecting channel into the remote region. In one exemplary arrangement, an outlet opening of the connecting channel to the remote region may be arranged or configured close to a mounting device and/or close to a bearing device, and the outlet opening may be arranged or configured so as to adjoin a mounting device and/or a bearing device directly. By way of the connecting channel, a fluid which is situated in the interior space which receives the clutch device, in particular a cooling and/or lubricating oil, can pass into a region which is remote from the interior space. Said fluid can be used for cooling and/or for lubrication of the mounting arrangement which is arranged between the input shaft and the housing body, in particular the first housing part body.

It is possible that a control fluid, in particular a control oil, can be conducted at least in sections to the clutch device in a first fluid channel which runs at least in sections in an interior space of the rotor shaft, in order to control the clutch device into defined operating states. For example, a controlling action can be exerted on the operating state of the clutch device in a manner which is dependent on the pressure of the control fluid which is situated in the fluid channel. For example, the clutch device can be configured as a multiple disk clutch. Here, controlling of the clutch device by the control fluid means controlling and/or regulating of the operating state or the operating states of the clutch device.

It is also possible that a lubricating and/or cooling fluid, in particular a lubricating and/or cooling oil can be conducted at least in sections to at least one mounting device and/or to at least one bearing device in a further fluid channel which runs at least in sections in an interior space of the rotor shaft and/or in an interior space of the input shaft. In this way, the rotor shaft and/or the input shaft are/is given a dual function, since the shaft or the shafts firstly at least temporarily has/have a torque transmission function and at the same time has or have a lubricating and/or cooling fluid conducting function or steering function.

A separating element for separating a section of a fluid channel to a section of a further fluid channel can be arranged, for example, at least in sections, in particular completely, in an interior space of the rotor shaft and/or in an interior space of the input shaft. In one exemplary arrangement, the separating element is configured as a sleeve. By way of the insertion of a separating element of, in one exemplary arrangement, rotationally symmetrical configuration into an interior space of the input shaft and/or the rotor shaft, the respective interior space can be divided into part spaces which are separate from one another in a way which is simple in terms of manufacturing and/or assembly. Said part spaces can be assigned, for example, to different fluid channels. The separating element can be fastened, for example, in a non-positive and/or positively locking and/or integrally joined manner in the interior space of the input shaft and/or in the interior space of the rotor shaft. The separating element can also be configured, for example, as a plug-in sleeve which is fastened in a clamping manner in the interior space. As an alternative or in addition, the separating element can be provided with a sealing device on its surface which faces the rotor shaft and/or the input shaft; in particular, the sealing device comprises at least one O-ring seal. The sealing device can be received or fastened in or on at least one sealing device receiving section of the separating element in such a way that the separating element with sealing device can be inserted in a linear joining movement into the interior space of the input shaft and/or rotor shaft, and the position of the sealing device relative to the separating element is maintained, in particular substantially. To this end, the sealing device receiving section of the separating element can be configured, for example, as a ring groove. If the separating element is configured as an element which is plugged into the interior space of the rotor shaft and/or input shaft, the separating element can have a stop region. Here, the stop region can bear or lie against a stop counter-face, in particular running radially, of the interior space of the rotor shaft and/or of the input shaft in the final assembly state. In this way, during the joining movement of the rotor shaft or input shaft and separating body, an end position limiting action can be brought about on the basis of the stop region, and finally simplified assembly is achieved. The separating element can be configured, for example, from plastic, whereas the rotor shaft and/or the input shaft can be manufactured from a metal, in particular from steel. The separating element can be configured, for example, in one piece or in multiple pieces.

It is possible that the input shaft comprises a holding section which is arranged or configured, in particular, on a surface which faces away from the rotor shaft, and the holding section may have an undercut region which can be engaged behind by way of a holding apparatus. The holding section can form, for example, by way of a holding section body which configures an undercut region at least in sections and is configured in one piece with the input shaft. In one exemplary arrangement, the holding section can be of rotationally symmetrical and/or rotatably symmetrical configuration. In one exemplary arrangement, the holding section preferably has an n-fold rotational symmetry, in accordance with which the holding section can be depicted on itself by being rotated about a central point or a central axis by at least a fixed angle (for example, by 180°, 120°, 90°, 72°, 60°, 51.4°, 45°, 40° or 36°).

In addition to the torque transmission apparatus, the disclosure also relates to a transmission arrangement for a vehicle which can be driven by way of a hybrid drive, in particular a motor vehicle, comprising an internal combustion engine and an electric machine which are connected or can be connected via a torque transmission apparatus as described herein to a transmission of the transmission arrangement. In other words, the transmission arrangement can comprise a drive train of a vehicle which can be driven by a hybrid drive. Here, the transmission arrangement can comprise a transmission which comprises, for example, a double clutch.

The disclosure also relates to a vehicle, and in one exemplary arrangement, a motor vehicle, comprising a hybrid drive for driving the vehicle, and a transmission arrangement as described herein.

As an alternative or in addition, the disclosure can relate to a method for assembling a torque transmission apparatus, in particular a torque transmission apparatus as described herein, which has the following steps: a) providing of an input shaft and a rotor shaft, the input shaft and the rotor shaft being mounted such that they can be moved rotationally with respect to one another via a mounting device which absorbs at least axial forces, b) holding of the input shaft by a holding apparatus on a holding section which is arranged or configured on the input shaft side, c) joining, and in one exemplary arrangement, by pressing, of a bearing device to or onto and/or into a section of the input shaft, no (for example, axial) joining forces acting on the mounting device during the joining operation as a result of the holding of the input shaft by way of the holding apparatus. By virtue of the fact that, during the joining process, in particular the pressing-in operation, of the assembly including the (first) bearing device and the housing part body onto the input shaft, the mounting device which is arranged or configured between the input shaft and the rotor shaft is held without force or is not loaded, damage of the mounting device can be prevented.

It can prove advantageous if, before the joining, an increase in a spacing from the input shaft to the rotor shaft takes place. Said spacing increase can be reduced, and in some exemplary arrangements, can be canceled completely, during the joining of the mounting device onto a section of the input shaft. In this way, it is made possible for an assembly of the rotor shaft and possibly connecting body and transmission shaft to be carried out first of all, with the result that there is a correspondingly assembled and possibly at least partially connected assembly, and for a partial release or, in particular slight, dismantling or pulling apart of the input shaft and the rotor shaft to subsequently be carried out, in order for it to be possible for a movement play for the application of a press-in force to be provided, or in order for it to be possible to compensate for, for example, tolerance-induced axial movements during the joining process, in particular the press-in process.

In a further alternative or additional aspect, the disclosure relates to a method for assembling a torque transmission apparatus, in particular a torque transmission apparatus as described herein, with the following steps: a) providing of an input shaft which is mounted via a bearing device with a housing body, for example with a housing part body, a spacer element which defines an axial spacing being arranged or being capable of being arranged between the input shaft and the housing part body, in particular between the input shaft and the bearing device, b) providing of a rotor shaft which is mounted or can be mounted in a rotationally movable manner with the input shaft via a mounting device which absorbs at least axial forces, the rotor shaft being connected in a torque-transmitting manner to a transmission shaft, and the transmission shaft being mounted via a mounting with a transmission housing, and the transmission housing being connected to a housing body which surrounds a clutch device and/or the input shaft and/or the rotor shaft at least in sections, c) bringing together c1) of a first assembly at least consisting of the input shaft, the bearing device and the housing part body, and c2) a further assembly at least consisting of the housing body, the transmission housing, the transmission shaft and the rotor shaft, c3) the spacer element being a constituent part of the first or the further assembly, d) measuring of a first axial spacing between d1) a first housing bodyside contact face for contact with the housing part body, and d2) a second input shaft-side contact face for contact with the spacer element;

e) measuring of a further axial spacing between e1) a third housing part body-side contact face for contact with the housing body, and e2) a fourth mounting device-side contact face for contact with the spacer element, f) selecting and/or specifying of a spacer element with a defined axial distance spacing on the basis of a comparison of the two measured axial spacings. Here, for example, an axial play on account of axial tolerances or on account of an axial tolerance chain of the components of the torque transmission apparatus and/or parts of the drive train, in particular the torque transmission apparatus and the transmission arrangement, can be kept low in an economical way by way of the spacer elements which are selected in a targeted manner based on the results of the measurements. The measurements of the first and the further axial spacing are preferably carried out before joining together of the assemblies. For example, the selected and/or specified spacer element can also be inserted between the assemblies before joining together of said assemblies, or can be attached and/or fastened (for example, non-positive connection) to one of the two assemblies, in order that it is situated at its intended location in the final assembly state of the two assemblies or is present as an element which is arranged between the assemblies.

All the advantages, details, arrangements and/or features of the torque transmission apparatus according to the disclosure can be applied to the transmission arrangement according to the disclosure and/or to the vehicle according to the disclosure and/or to the method according to the disclosure, and vice versa.

### BRIEF DESCRIPTION OF THE DRAWINGS

The disclosure is described in greater detail on the basis of exemplary arrangements in the drawings, in which:

FIG. 1 shows a diagrammatic outline illustration of a torque transmission apparatus in accordance with one exemplary arrangement,

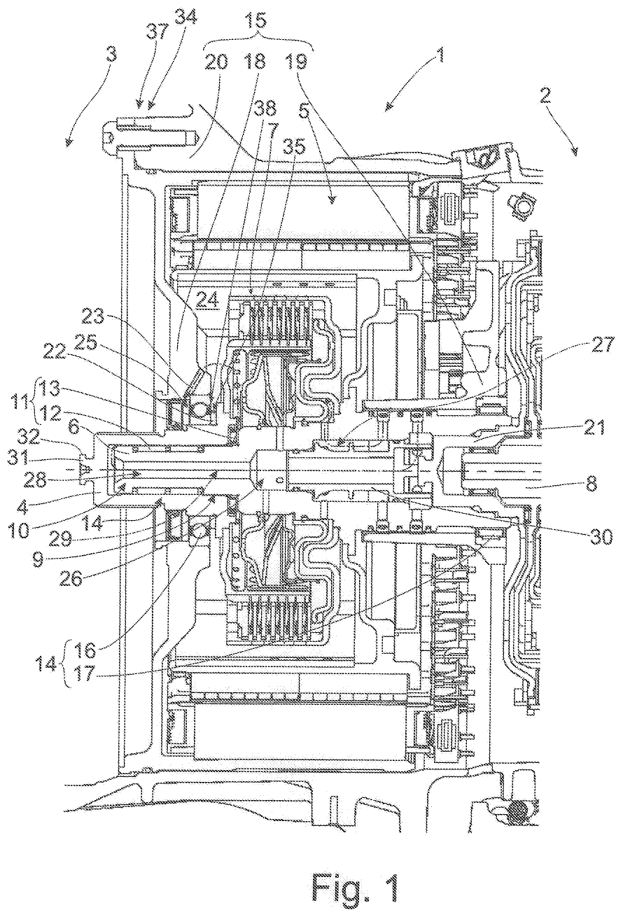

FIG. 2 shows a diagrammatic detailed illustration of an interface of the torque transmission apparatus, which interface faces an internal combustion engine, and

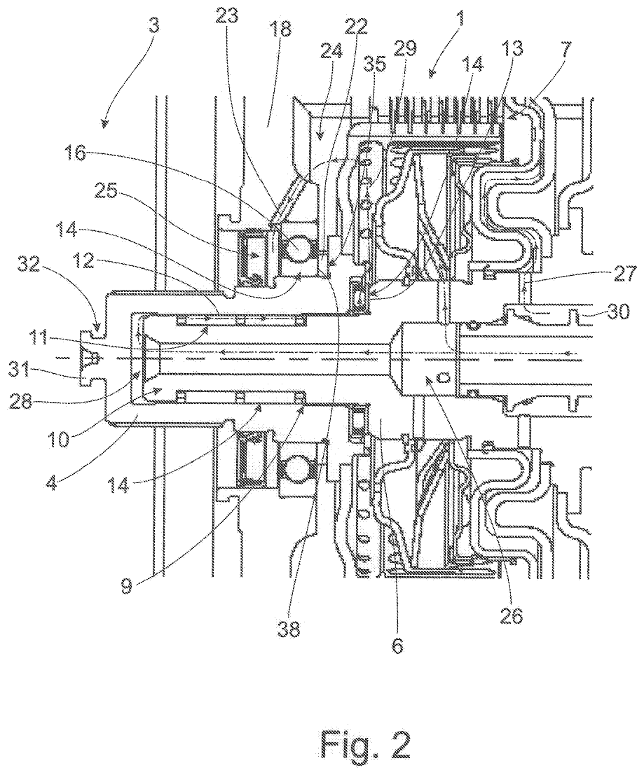

FIG. 3 shows a diagrammatic detailed illustration of an interface of the torque transmission apparatus, which interface faces a transmission.

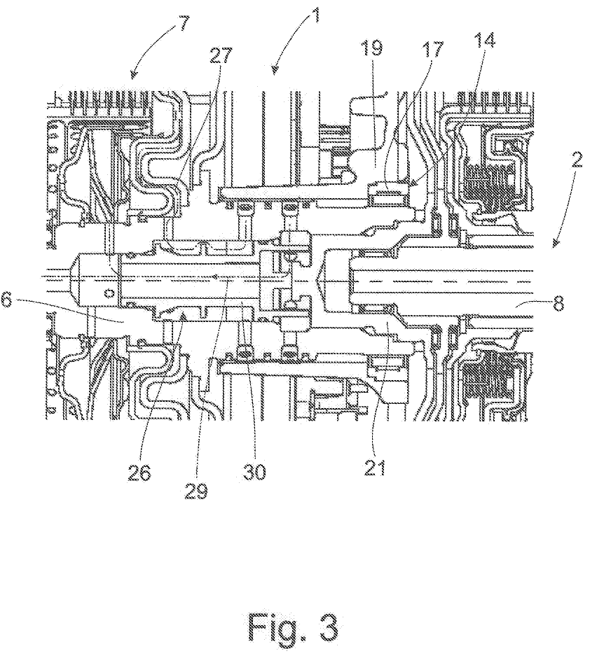

### DETAILED DESCRIPTION

Torque transmission apparatus 1 for the transmission of a torque to a transmission 2 of a vehicle (not shown) which can be driven via a hybrid drive. The internal combustion engine 3 and the transmission 2 are not shown or are shown merely in fractional amounts in the figures. The torque transmission apparatus 1 comprises an input shaft 4 which can be connected or is connected in a torque-transmitting manner to the internal combustion engine 3, and a rotor shaft 6 which can be connected or is connected in a torque-transmitting manner to an electric machine 5. The electric machine 5 comprises a stator which is arranged on or fastened to a housing body 15, and a rotor which is arranged on or fastened to a rotor shaft 6.

The input shaft 4 and the rotor shaft 6 are connected or can be connected at least temporarily in a torque-transmitting manner via a clutch device 7, the clutch device 7 being configured a), in a first operating state of the clutch device 7, to transmit a torque between the input shaft 4 and a transmission shaft 8 which is assigned to a transmission 2, in particular via the rotor shaft 6, and b), in a further operating state, to transmit a reduced torque or no torque between the input shaft 4 and the transmission shaft 8. Here, the input shaft 4 can have a receiving section 9, in particular in the form of a recess, for indirect or direct receiving of a section 10 of the rotor shaft 6 (see figures) and/or the rotor shaft 6 can have a receiving section, in particular in the form of a recess, for indirect or direct receiving of a section of the input shaft 4 (not shown).

The rotor shaft 6 and the input shaft 4 can be oriented coaxially with respect to one another, and the rotor shaft 6 and the input shaft 4 can be configured as a hollow shaft. In one exemplary arrangement which is shown, the input shaft 4 is configured as a hollow shaft which is closed on one end side, and the rotor shaft 6 is configured as a hollow shaft which configures a continuous central channel.

The input shaft 4 and the rotor shaft 6 are mounted such that they can be moved rotationally with respect to one another directly via a mounting device 11. Here, the mounting device 11 has at least one radial mounting arrangement 12 and at least one axial mounting arrangement 13. Said two mounting devices 11, 12, 13 mount the input shaft 4 and the rotor shaft 6 directly with one another, that is to say without a further element being connected in between.

In the exemplary arrangement shown, the mounting device 11 is arranged or received completely in an inner region 14 or receiving section 9 of the input shaft 4 which receives the rotor shaft 6 or the section 10 of the rotor shaft 6. All mounting arrangements 12, 13 of the mounting device 11 are may be received in the inner region 14 or in the receiving section 9 of the input shaft 4. This leads to a compact overall design and, at the same time, to a stable construction of the torque transmission apparatus 1.

In the exemplary arrangement shown, the input shaft 4 and the rotor shaft 6 are mounted directly via a bearing device 14 with a housing body 15 which surrounds the clutch device 7 and/or the input shaft 4 and/or the rotor shaft 6 at least in sections, in particular completely. In other words, the housing body 15 surrounds or encloses the clutch device 7 and possibly parts of the input shaft 4 and/or the rotor shaft 6 at least in sections, and in some instances, completely. Here, the bearing device 14 can comprise, for example, a first bearing means 16 and at least one further bearing arrangement 17.

The input shaft 4 may be mounted via the first bearing apparatus 16 on a housing part body 18 of the housing body 15, and the rotor shaft 6 may be mounted via a further bearing arrangement 17 on a further housing part body 19 of the housing body 15. In the exemplary arrangement shown, the housing body 15 is constructed in three pieces by way of example, a first housing part body 18 being arranged on a central housing part body 20 on its first axial end section (pointing toward the internal combustion engine) of the housing part body 20, and a further housing part body 19 being arranged on a further end section of the central housing part body 20, which further end section, may be remote from the first axial end section. In the exemplary arrangement shown, the housing part bodies 18, 19, 20 are connected to one another in a non-positive and/or positively locking manner or form a joint assembly. Here, the central housing part body 20 is configured as a body which configures a cavity, said cavity being delimited or closed off laterally by way of the substantially radially extending first and further housing part bodies 18, 19. The first and the further housing part body 18, 19 in each case have a central passage opening, through which the input shaft 4 and/or the rotor shaft 6 and/or a connecting body, for example, a connecting shaft 21, pass/passes or can pass. Here, the first bearing arrangement 16 and the further bearing arrangement 17 form the interfaces in or on the passage openings of the housing part bodies 18, 19 to the elements which penetrate them (input shaft 4, rotor shaft 6 and/or connecting body 22). The connecting body or the connecting shaft 21 can be connected to the rotor shaft 6 in a plug-in connection, and, in this way, axial forces can be introduced from the transmission or from the transmission shaft via the rotor shaft and the ball bearing in the first housing part body 18.

A spacer element 22 is arranged between the input shaft 4 and a housing body 15 which surrounds the clutch device 7 and/or the input shaft 4 and/or the rotor shaft 6 at least in sections. A defined spacing in the axial direction between the input shaft 4 and the housing body 15, and in one exemplary arrangement, between the input shaft 4 and the housing part body 18 which may face the internal combustion engine in the final assembly state, is set or produced by way of the spacer element 22. Here, a first bearing arrangement 16 can be arranged between the input shaft 4 and the housing part body 18. It is possible for the spacer element 22 to be arranged on that surface of the first bearing arrangement 16 which faces the input shaft 4.

A housing body 15 which surrounds the clutch device 7 and/or the input shaft 4 and/or the rotor shaft 6 at least in sections can comprise a connecting channel 23 which connects a housing body space 24 which receives the clutch device 7 to a region 25 which is remote from said housing body space 24, in such a way, that in the use as intended of the torque transmission apparatus 1, a fluid which is situated in the housing body space 24 passes via the connecting channel 23 into the remote region 25. An outlet opening of the connecting channel 23, which outlet opening is directed toward the remote region 25, may be arranged or configured close to a mounting device 11 and/or close to a bearing device 14. In one exemplary arrangement, the outlet opening of the connecting channel 23 is arranged or configured so as to adjoin a mounting device 11 and/or a bearing device 14 directly. In the embodiment which is shown, the outlet opening of the connecting channel 23 adjoins the first bearing arrangement 16 of the bearing device 14. In one exemplary arrangement, the first bearing arrangement 16 is configured as a radial and axial bearing. The connecting channel 23 can be oriented, for example, so as to run towards the center or toward the rotational axis in a direction which is directed toward the outer end of the input shaft 4.

The torque transmission apparatus 1 can comprise, for example, a first fluid channel which runs at least in sections in an interior space 26 of the rotor shaft 6 (cf. arrow 27) for conducting a control fluid, in particular a control oil, to the clutch device 7, in order to control the clutch device 7 into defined operating states. In addition, the torque transmission apparatus 1 can comprise a further fluid channel which runs at least in sections in an interior space 26 of the rotor shaft 6 and/or in an interior space 28 of the input shaft 4 (cf. arrow 29) for conducting a lubricating and/or cooling fluid, in particular a lubricating and/or cooling oil, said further fluid channel 29 leading at least to at least one mounting device 11 and/or to at least one bearing device 14.

A separating element 30 for separating a section of a fluid channel 27 with respect to a section of a further fluid channel 28 can be received at least in sections, in particular completely, in an interior space 26 of the rotor shaft 6 and/or in an interior space 28 of the input shaft 4. In one exemplary arrangement, the separating element 30 is configured as a sleeve which may be fabricated from plastic, and is optionally fixed in a clamping manner in the interior space 26 of the rotor shaft.

The input shaft 4 may comprise, for example, a holding section 31 which is arranged or configured, in particular, on a surface which faces away from the rotor shaft 6. In one exemplary arrangement, the holding section 31 may have an undercut region 32 which can be engaged behind by way of a holding apparatus.

In addition to the torque transmission apparatus 1, the disclosure comprises a transmission arrangement for a vehicle which can be driven by way of a hybrid drive, in particular a motor vehicle, comprising an internal combustion engine 3 and an electric machine 5 which are connected or can be connected via a torque transmission apparatus 1 as described herein to a transmission 2 of the transmission arrangement.

In an optional method for the assembly of a torque transmission apparatus 1, in particular a torque transmission apparatus 1 as described herein, the following steps can be provided: a) providing of an input shaft 4 and a rotor shaft 6, the input shaft 4 and the rotor shaft 6 being mounted such that they can be moved rotationally with respect to one another via a mounting device 11 which absorbs at least axial forces, and in one exemplary arrangement, via at least one axial mounting arrangement 13, b) holding of the input shaft 4 by a holding apparatus (not shown) on a holding section 31 which is arranged or configured on the input shaft side, c) joining, and in one exemplary arrangement, by pressing, of a bearing device 14 to or onto and/or into a section of the input shaft 4, such that no joining forces act on the mounting device 11, and in one exemplary arrangement, no joining forces act on the axial mounting arrangement 13, during the joining operation as a result of the holding of the input shaft 4 by way of the holding apparatus.

As an alternative or in addition, it can be provided that, in a method for the assembly of a torque transmission apparatus 1, for example a torque transmission apparatus 1 as described herein, the following steps are carried out: a) providing of an input shaft 4 which is mounted via a bearing device 14 with a housing part body 18, 19, 20, a spacer element 22 which defines an axial spacing being arranged or being capable of being arranged between the input shaft 4 and the housing part body 18, 19, 20, and in one exemplary arrangement, between the input shaft 4 and the first bearing arrangement 16, b) providing of a rotor shaft 6 which is mounted or can be mounted in a rotationally movable manner with the input shaft 4 via a mounting device 11 which absorbs at least axial forces, the rotor shaft 6 being connected in a torque-transmitting manner to a transmission shaft 8, and the transmission shaft 8 being mounted via a mounting with a transmission housing, and the transmission housing being connected to a housing body 15 which surrounds a clutch device 7 and/or the input shaft 4 and/or the rotor shaft 6 at least in sections, c) bringing together c1) of a first assembly at least including the input shaft 4, the bearing device 14, in particular the first bearing arrangement 16, and the housing part body 18, and c2) a further assembly at least consisting of a constituent part of the housing body 15, in particular at least of the central housing part body 20, the transmission housing, the transmission shaft 8 and the rotor shaft 6, c3) the spacer element 22 being a constituent part of the first or the further assembly, d) measuring of a first axial spacing between d1) a first housing part body-side contact face 34 of the central housing part body 20 for contact with the housing part body 18, and d2) a second input shaftside contact face 35 for contact with the spacer element 22; e) measuring of a further axial spacing between e1) a third housing part body-side contact face 37 of the first housing part body 18 for contact with a housing part body 19, 20, in particular with the central housing part body 20, and e2) a fourth mounting device-side contact face 38 for contact with the spacer element 22, f) selecting and/or specifying of a spacer element 22 with a defined axial distance spacing on the basis of a comparison of the two measured axial spacings.

In other words, a first axial spacing between the contact faces 34 and 35 and a further axial spacing between the contact faces 37 and 38 are determined, and a spacer element 22 with a defined thickness or with a defined axial extent is installed into the torque transmission apparatus 1 in a manner which is dependent on a difference or a relation of said two spacings.

1. A torque transmission apparatus for the transmission of a torque to a transmission of a vehicle which can be driven via a hybrid drive, comprising:
an input shaft which can be connected or is connected in a torque-transmitting manner to an internal combustion engine,
a rotor shaft which can be connected or is connected in a torque-transmitting manner to an electric machine, and
a clutch device which connects the input shaft and the rotor shaft at least temporarily in a torque-transmitting manner, the clutch device being configured,
in a first operating state of the clutch device, to transmit a torque between the input shaft and a transmission shaft which is assigned to a transmission via the rotor shaft, and,
in a further operating state of the clutch device, to transmit a reduced torque or no torque between the input shaft and the transmission shaft,
wherein the input shaft further comprises a receiving section for indirectly or directly receiving a section of the rotor shaft, and/or
the rotor shaft having a receiving section for indirectly or directly receiving a section of the input shaft.

2. The torque transmission apparatus as claimed in claim 1, wherein the rotor shaft and the input shaft are oriented coaxially with respect to one another, and the rotor shaft and/or the input shaft are/is configured as a hollow shaft.

3. The torque transmission apparatus as claimed in claim 1, wherein the input shaft and the rotor shaft are mounted, via a mounting device such that the input shaft and the rotor shaft can be moved rotationally with respect to one another, and wherein the mounting device has at least one radial mounting arrangement and at least one axial mounting arrangement.

4. The torque transmission apparatus as claimed in claim 3, wherein the mounting device is at least partially received in
an inner region of the input shaft, which inner region receives the rotor shaft, or
in an inner region of the rotor shaft, which inner region receives the input shaft,
and all the mounting arrangements of the mounting device are received in an inner region of the rotor shaft or of the input shaft.

5. The torque transmission apparatus as claimed in claim 1, wherein the input shaft and/or the rotor shaft are/is mounted via a bearing device with a housing body which surrounds the clutch device and/or the input shaft and/or the rotor shaft at least in sections, and the input shaft is mounted via a first bearing arrangement on a housing part body of the housing body, and the rotor shaft is mounted via a further bearing arrangement on a further housing part body of the housing body.

6. The torque transmission apparatus as claimed in claim 1, wherein a spacer element is arranged between the input shaft and a housing body which surrounds the clutch device and/or the input shaft and/or the rotor shaft at least in sections, and a defined spacing is produced in an axial direction between the input shaft and the housing body by the spacer element.

7. The torque transmission apparatus as claimed in claim 1, wherein a housing body which surrounds the clutch device and/or the input shaft and/or the rotor shaft at least in sections comprises a connecting channel which connects a housing body space which receives the clutch device to a region which faces away from said housing body space in such a way that, when the torque transmission apparatus is used as intended, a fluid which is situated in the housing body space passes via the connecting channel into the remote region, an outlet opening of the connecting channel to the remote region is arranged close to a mounting device and/or close to a bearing device, and the outlet opening is arranged so as to adjoin a mounting device and/or a bearing device directly.

8. The torque transmission apparatus as claimed in claim 1, comprising a first fluid channel which runs at least in sections in an interior space of the rotor shaft for conducting a control fluid, to the clutch device, in order to control the clutch device into defined operating states.

9. The torque transmission apparatus as claimed in claim 1, further comprising a further fluid channel which runs at least in sections in an interior space of the rotor shaft and/or in an interior space of the input shaft for conducting a lubricating and/or cooling fluid, to at least one mounting device and/or to at least one bearing device.

10. The torque transmission apparatus as claimed in claim 1, wherein a separating element for separating a section of a fluid channel from a section of a further fluid channel is received at least in sections, in an interior space of the rotor shaft and/or in an interior space of the input shaft, and the separating element is configured as a sleeve.

11. The torque transmission apparatus as claimed in claim 1, wherein the input shaft comprises a holding section which is arranged on a surface which faces away from the rotor shaft, and the holding section has an undercut region which can be engaged behind by way of a holding apparatus.

12. A transmission arrangement for a vehicle which can be driven by way of a hybrid drive, comprising an internal combustion engine and an electric machine which are connectable via a torque transmission apparatus as claimed in claim 1 to a transmission of the transmission arrangement.

13. A vehicle comprising a hybrid drive for driving the vehicle, and a transmission arrangement as claimed in claim 12.

14. A method for assembling a torque transmission apparatus comprising:
providing an input shaft and a rotor shaft, the input shaft and the rotor shaft being mounted such that the input shaft and the rotor shaft can be moved rotationally with respect to one another via a mounting device which absorbs at least axial forces,
holding the input shaft by a holding apparatus on a holding section which is arranged on an input shaft side,
joining a bearing device to or onto and/or into a section of the input shaft with no joining forces acting on the mounting device during the joining operation as a result of holding the input shaft by way of the holding apparatus.

15. A method for assembling a torque transmission apparatus comprising:
a) providing an input shaft which is mounted via a bearing device with a first housing part body, a spacer element which defines an axial spacing being arranged between the input shaft and the first housing part body,
b) providing a rotor shaft which is mounted in a rotationally movable manner with the input shaft via a mounting device which absorbs at least axial forces, the rotor shaft being connected in a torque-transmitting manner to a transmission shaft, and the transmission shaft being mounted via a mounting with a transmission housing, and the transmission housing being connected to a housing body which surrounds a clutch device and/or the input shaft and/or the rotor shaft at least in sections,
c) bringing together
c1) a first assembly that includes the input shaft, the bearing device and the first housing part body, and
c2) a further assembly that includes a constituent part of the housing body, the transmission housing, the transmission shaft and the rotor shaft,
c3) the spacer element being a constituent part of the first or the further assembly,
d) measuring a first axial spacing between
d1) a first housing body-side contact face for contact with the first housing part body, and
d2) a second input shaft-side contact face for contact with the spacer element;
e) measuring of a further axial spacing between
e1) a third housing part body-side contact face for contact with the housing body, and
e2) a fourth mounting device-side contact face for contact with the spacer element,
f) selecting and/or specifying a spacer element with a defined axial distance spacing on the basis of a comparison of the two measured axial spacings.

16. The method for assembling a torque transmission apparatus claim 15, wherein the spacer element is positioned between the input shaft and the bearing device which is arranged on the housing part body side.

17. The torque transmission apparatus as claimed in claim 1, wherein the rotor shaft and the input shaft are oriented coaxially with respect to one another, and the rotor shaft and/or the input shaft are/is configured as a hollow shaft defining a fluid channel, wherein a separating element for separating a section of the fluid channel from a section of a further fluid channel is received in an interior space of the rotor shaft and/or in an interior space of the input shaft.

18. The torque transmission apparatus as claimed in claim 17, wherein the separating element is configured as a sleeve that is fixed in hollow shaft of the rotor.

19. The torque transmission apparatus as claimed in claim 1, wherein a housing body surrounds the clutch device, and wherein the housing body comprises a connecting channel that connects a housing body space that receives the clutch device to a region that is remote from the housing body space such that a fluid situated in the housing body space passes via the connecting channel into the remote region.

20. The torque transmission apparatus of claim 19, wherein an outlet opening of the connecting channel is arranged to directly adjoin a bearing device.
